(19) United States
(12) Patent Application Publication
(10) Pub. No.: US 2026/0154270 A1
(43) Pub. Date: Jun. 4, 2026

(54) RETRIEVING CHANGES IN TEMPORAL ORDER FROM MULTIPLE DATA STORES DURING REPARTITION

(71) Applicant: MICROSOFT TECHNOLOGY LICENSING, LLC, Redmond, WA (US)

(72) Inventors: Lei ZHOU, Redmond, WA (US); Bradley James BARROWS, Redmond, WA (US); Shruti KASETTY, Bellevue, WA (US); Danni LI, Bothell, WA (US); Michael Henry SCHULZ, Raleigh, NC (US); Anish AGARWAL, Bothell, WA (US)

(21) Appl. No.: 18/964,166

(22) Filed: Nov. 29, 2024

(51) Int. Cl. G06F 16/2455; G06F 16/23

(52) U.S. Cl. CPC G06F 16/24554; G06F 16/2322

(57) ABSTRACT

A request is received for a synchronization of data for a tenant of a multi-tenant database service, the data being stored in multiple partitions of a partitioned database. A single sync token comprising a set of sort keys is used to identify a deterministic order for changes in the data for the tenant including when timestamps for a change are identical. The changes are sorted by time, tenant, object, and property. All partitions of the partitioned database are queried, and sort and deduplication are performed to determine a set of changes to be provided in response to the request.

### BACKGROUND

When implementing multi-tenant architectures in Structured Query Language (SQL) databases, tenants may share a database or application instance but are logically isolated. Tenant directory data identifies which tenant owns or has access to specific data. It is a challenge to ensure consistent and accurate retrieval of data changes where tenant directory data is partitioned across multiple SQL databases. It is with respect to these and other considerations that the disclosure made herein is presented.

### SUMMARY

When tenants are moved between directory partitions (e.g., for rebalancing) or to new partitions (e.g., repartitioning) for capacity management, various issues can arise, such as replaying changes that have already been synchronized, failing to capture unsynchronized changes, and applying changes out of order. Such issues can lead to inconsistencies for the clients and potentially loss of data.

The disclosed embodiments describe technologies that ensure that changes in such systems are retrieved in a deterministic temporal order by clients, even in the presence of repartitioning, which enables the systems to maintain data consistency and integrity. In various embodiments, a single sync token is used to retrieve changes from multiple partitions, ensuring that changes are ordered deterministically even when multiple changes have the same timestamp among partitions. In an embodiment, changes are sorted by time, tenant, object, and property. In an embodiment, a middle-tier component maintains a watermark to exclude recent changes, thus preventing issues with change ordering. Tenant states in both source and destination databases are used to determine where changes should be sourced from, especially in cases of tenant movement. This approach allows multi-partition synchronization to be handled in a way that prevents data loss, ensures consistency, and correctly orders changes, even in complex scenarios involving tenant rebalancing/repartition.

The disclosed technologies provide the technical benefits of ensuring that changes in multi-tenant database systems are retrieved and applied in the correct temporal order, using watermarks to avoid processing changes that are too recent to be ordered correctly. The disclosed technologies prevent data inconsistencies that could arise from tenant rebalancing/repartition. The disclosed technologies provide robustness in multi-partition environments through the use of a single sync token to provide deterministic ordering that mitigates issues caused by tenant moves across partition and ensuring that changes are neither lost nor duplicated. The disclosed technologies provide scalability and enable database solutions to handle the complexities of large, distributed environments where tenants may frequently move between partitions. Additionally, the disclosed technologies provide improved fault tolerance by accounting for client-side issues such as cookie replay and rollback, ensuring that retries and failovers do not result in inconsistent data states.

This Summary is provided to introduce a selection of concepts in a simplified form that are further described below in the Detailed Description. This Summary is not intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, same reference numbers in different figures indicate similar or identical items.

FIG. 1 illustrates an example architecture in accordance with the present disclosure.

FIG. 2 illustrates an example state table in accordance with the present disclosure.

FIG. 3 illustrates an example system diagram in accordance with the present disclosure.

FIG. 4 illustrates an example procedure in accordance with the present disclosure.

FIG. 5 illustrates an example architecture in accordance with the present disclosure.

### DETAILED DESCRIPTION

Described herein are technologies that allow for improvements in the performance of multi-tenant architectures in SQL databases. When tenants are moved between directory partitions (e.g., for rebalancing) or to new partitions (e.g., repartitioning) for capacity management, various issues can arise, such as replaying changes that have already been synchronized, failing to capture unsynchronized changes, and applying changes out of order. Such issues can lead to inconsistencies and inefficiencies for the clients and potentially loss of data. The disclosed embodiments include ways to ensure that changes in such systems are retrieved in a deterministic temporal order by clients, even in the presence of repartitioning, which allows the service provider to maintain data consistency and integrity.

Distributed database systems typically have multiple partitions. Directory data, which is partitioned by tenants, are sometimes moved from one partition to another for various purposes:

Load Balancing—as directory services grow, some partitions can end up handling more load than others. Rebalancing is performed to ensure that each partition handles a roughly equal share of the load, optimizing overall performance.

Resource Utilization—over time, some partitions can accumulate more data and hence use more resources. Rebalancing allows resources to be reallocated so that each partition uses resources more efficiently.

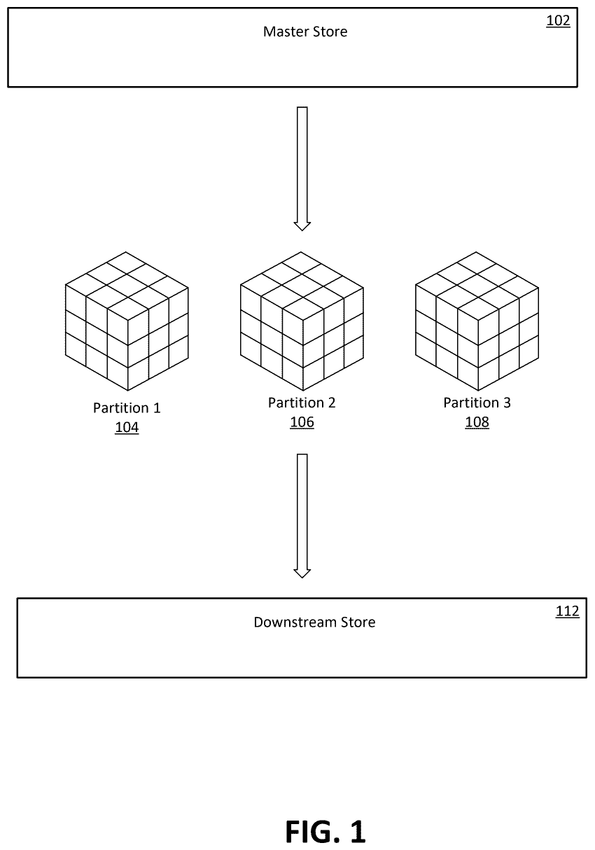

Referring to FIG. 1, the upstream or master store 102 continuously updates data such as objects and properties of partition 1 104, partition 2 106, and partition 3 108. Data is moved between partitions for balancing. The downstream store 112 consumes the data and must receive correct and update to data information from the partitions 104, 106, 108. A global virtual order of all changes across all like partitions is thus needed. Additionally, data that is in the process of being moved should be included without loss and without redundancy.

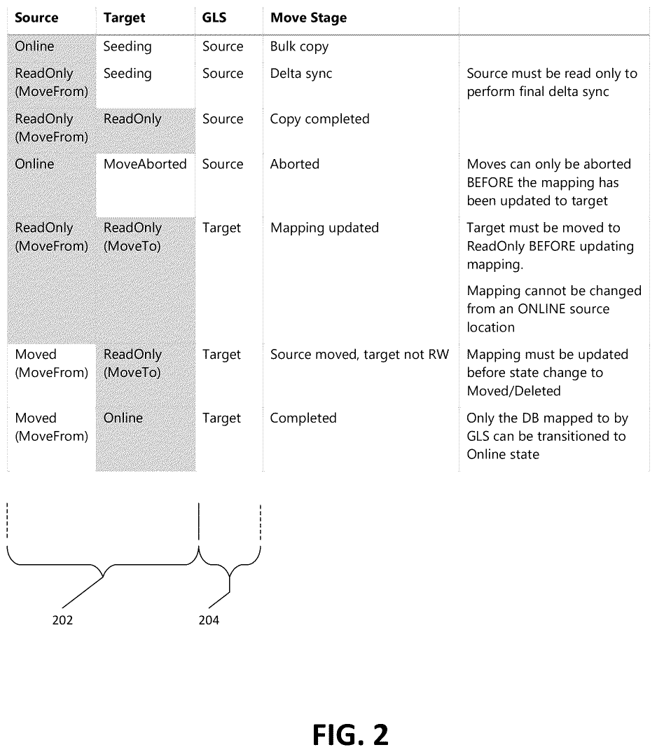

Referring to the table illustrated in FIG. 2, it is determined from the status information how to respond to a synchronization request. As described herein, the determination is based on the status on both sides (source or target 202) and the watermark in the cookie.

Generally, the present disclosure describes a way to use a single sync token to retrieve changes from multiple partitions, ensuring that changes are ordered deterministically even when multiple changes have the same timestamp among partitions. Changes are sorted by time, tenant, object, and property. In an embodiment, a middle-tier component maintains a watermark to exclude recent changes, thus preventing issues with change ordering. The middle-tier component is also referred to herein as a middle layer. Tenant states in both source and destination databases are used to determine where changes should be sourced from, especially in cases of tenant movement. This approach allows multi-partition synchronization to be handled in a way that prevents data loss, ensures consistency, and correctly orders changes, even in complex scenarios involving tenant rebalancing/repartition.

In an embodiment, a single sync token is used to query multiple databases in a deterministic order using a set of sort keys. In an embodiment, the sort keys include time, tenant ID, object ID, and property ID. A deterministic order is determined even for the same timestamps using the sort keys. In an embodiment, a middle tier is implemented that maintains a watermark to exclude changes that are too recent to guarantee correct ordering.

Tenant states in both the source and target databases (Online, Seeding, ReadOnly, Moved) are used to determine which side should be used for moved changes.

All partitions in a sync boundary are combined as a single view to have a global deterministic order of changes by timestamp, tenant ID, object ID and property ID. A single cookie (combination of timestamp, tenant ID, object ID and property ID for extended properties, timestamp and record ID for links) is used to represent a unique sync position in a common global view.

Sync requests are served by querying all partitions and performing sort and deduplication to obtain intermediate results in the middle-tier component.

Data may not be synchronously written to all partitions, so it is possible that newer changes can be written to one partition before older changes reach another. To address this issue, a watermark is implemented to limit the visible range to a point that all partitions have reached when combining view from multiple partitions. In one embodiment, the watermark is set as the current date and time.

The watermark represents the earliest last timestamp from a full page that the middle tier has seen. Any changes beyond that point from all partitions are discarded so that the changes can be seen in the global order in following syncs. This prevents such changes from being lost.

If a full page is not received from a partition, the heartbeat is further checked to account for delayed backup replication.

```
DateTime Converge(watermark, db changes, heartbeat)
{
  if (db changes.count == PageSize) // only converge for full page
    watermark = min(watermark, db changes.SyncToken)
  else
    watermark = min(watermark, heartbeat)
  return watermark
}
```

For each partition, a page is obtained with size N, based on the token, skew offset, and heartbeat. The watermark is converged if a full page is obtained, based on the watermark, database changes, and heartbeat. The changes are sorted and deduplicated. Changes more recent than the watermark are discarded, and the final set of changes are returned. Deduplication generally refers to the identification and removal of duplicate data in the changes.

There can be differences in the clocks between different servers and it is possible that race conditions allow a longer running transaction to commit after a shorter transaction with a slightly older timestamp. To adjust for these variances, in an embodiment, changes are excluded that are newer than some offset (e.g. 30 seconds) and only items older than that time are returned.

Similar to time skew issue, delayed replication between primary and backup replicas can also impact the correctness of the results if it is decided to allow sync queries to the replica database. In an embodiment, a heartbeat is implemented on each partition representing the last time that the partition was regularly updated. The heartbeat is used to converge the watermark when the returned page from a partition is not full.

Referring to FIG. 2, in an embodiment, tenant states 202 are maintained in both source and target databases. When querying databases, tenants in some specific states are ignored/skipped so that only data from a valid data origin (e.g., cells in blue) are retrieved when both sides contain data for a moving or moved tenant.

In an embodiment, the table in FIG. 2 shows the possible states of a move, based on the tenant states 202 on the source and target partition and the authoritative location 204 from the global lock service (GLS). The state combination of source and target in the table are used to determine a valid data origin when both sides return data for a moving (moved) tenant. Cells in blue represent valid data origin for synchronization.

Copied changes can be returned from both source and target databases. To ensure that the correct version is returned considering the stage of the tenant move, the rules shown below are used to determine the correct origin of copied changes in accordance with the state machine described in FIG. 2.
Changes can be returned in Online/Active and Read Only states.
Changes are filtered in Moved, Seeding and Aborted states.
Changes may be returned by both databases in Read Only state.

The transition is performed while updating the mapping. De-duplication is not an issue since when in Read Only state, both databases have the exact same data for the tenant if the target version has not been updated after the move. Changes with the tenant table are joined to obtain the state and those with Seeding, Aborted and Moved are discarded.

When consolidating changes returned from multiple databases, the middle-tier component maintains an in-memory watermark to exclude changes that are too recent to guarantee data integrity and correct ordering, which addresses clock skew and network latency in distributed systems. The algorithm above illustrates an example implementation.

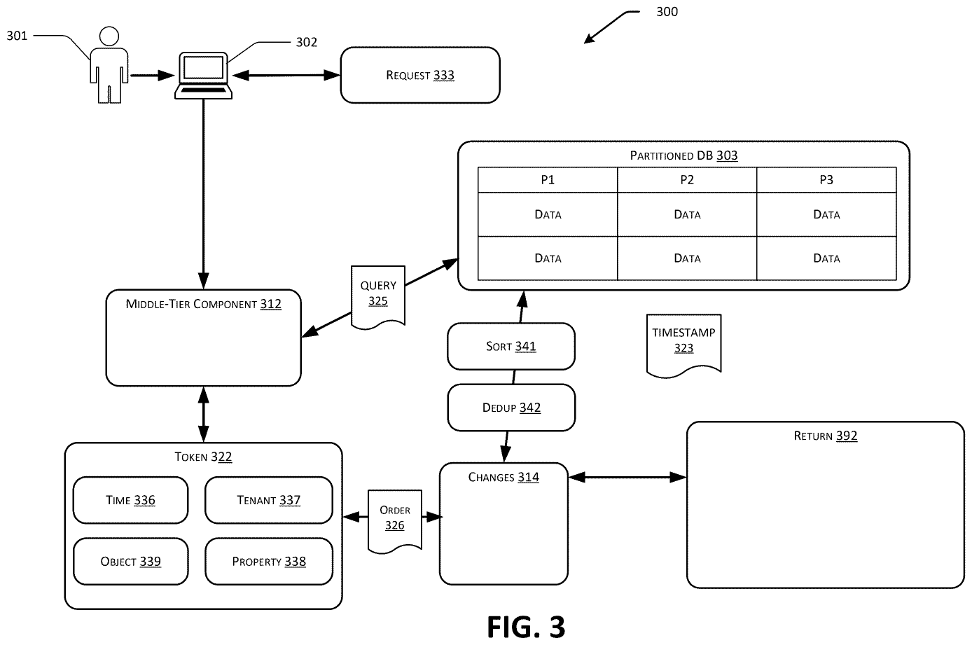

FIG. 3 illustrates an example for performing a database synchronization operation during a repartitioning or rebalancing of a partitioned database in a distributed computing system 300 providing a multi-tenant database service, in an embodiment. A system or device 302 receives a request 333 for a synchronization of data for tenant 301 of the multi-tenant database service. The data is stored in multiple partitions of the partitioned database 303. In response to the request 333, a single sync token 322 comprising a set of sort keys 336, 337, 338, 339 is generated. The single sync token 322 is used to identify a deterministic order 326 for changes 314 in the data for the tenant 301 including when timestamps 323 for a change are identical. The changes are sorted by time 336, tenant 337, object 339, and property 338. All partitions of the partitioned database 303 queried 325. Sort 341 and deduplication 342 are performed to determine a set of changes 314 to be provided in response to the request 333. The set of changes 314 are returned 392.

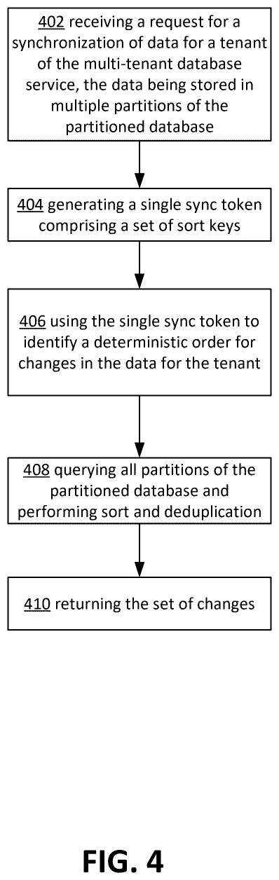

Turning now to FIG. 4, illustrated is an example operational procedure for performing a database synchronization operation during a repartitioning or rebalancing of a partitioned database in a distributed computing system providing a multi-tenant database service in accordance with the present disclosure. The operational procedure may be implemented in a system comprising one or more computing devices.

It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a computing device, it can be appreciated that this routine can be performed on any computing system which may include a number of computers working in concert to perform the operations disclosed herein.

Thus, it should be appreciated that the logical operations described herein are implemented (1) as a sequence of computer implemented acts or program modules running on a computing system such as those described herein and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Referring to FIG. 4, operation 402 illustrates receiving a request for a synchronization of data for a tenant of the multi-tenant database service, the data being stored in multiple partitions of the partitioned database.

Operation 404 illustrates in response to the request, generating a single sync token comprising a set of sort keys.

Operation 406 illustrates using the single sync token to identify a deterministic order for changes in the data for the tenant including when timestamps for a change are identical, wherein the changes are sorted by time, tenant, object, and property.

Operation 408 illustrates querying all partitions of the partitioned database and performing sort and deduplication to determine a set of changes to be provided in response to the request.

Operation 410 illustrates returning the set of changes.

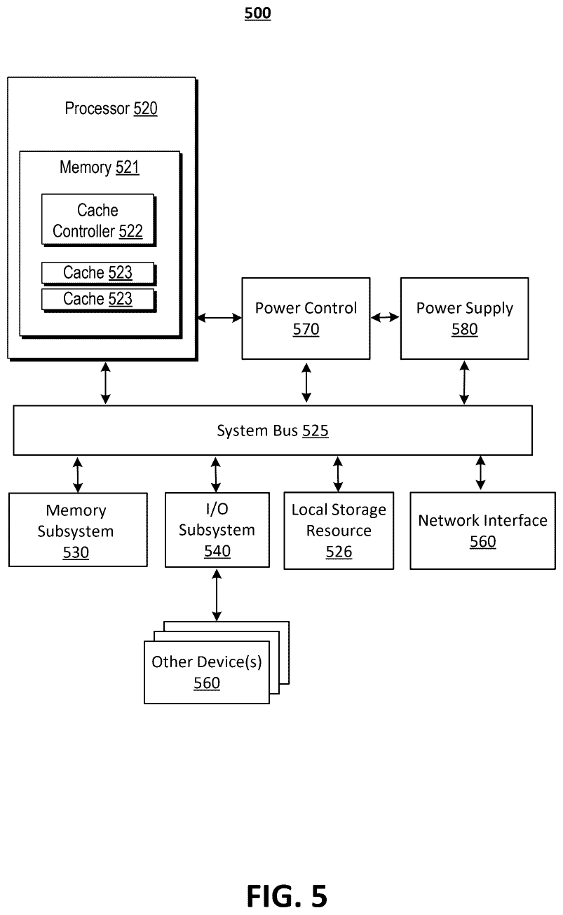

FIG. 5 illustrates a block diagram depicting selected elements of an embodiment of a computing environment 500. As described herein, computing environment 500 may represent a computing device such as a personal computer system, a desktop computer, a server, etc. As shown in FIG. 5, components of computing environment 500 may include, but are not limited to, processor subsystem 520, which may comprise one or more processors, and system bus 525 that communicatively couples various system components to processor subsystem 520 including, for example, a memory subsystem 530, an I/O subsystem 540, local storage resource 526, and a network interface 560. System bus 525 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

In FIG. 5, network interface 560 may be a suitable system, apparatus, or device operable to serve as an interface between computing environment 500 and a network (not shown in FIG. 5). Network interface 560 may enable computing environment 500 to communicate over the network using a suitable transmission protocol and/or standard, including, but not limited to, transmission protocols and/or standards. In some embodiments, network interface 560 may be communicatively coupled via the network to a network storage resource (not shown). The network coupled to network interface 560 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). The network coupled to network interface 560 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. The network coupled to network interface 560 and/or various components associated therewith may be implemented using hardware, software, or any combination thereof.

As depicted in FIG. 5, processor subsystem 520 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 520 may interpret and/or execute program instructions and/or process data stored locally (e.g., in memory subsystem 530). In the same or alternative embodiments, processor subsystem 520 may interpret and/or execute program instructions and/or process data stored remotely (e.g., in a network storage resource, not shown).

As illustrated in FIG. 5, a memory subsystem 521 within processor subsystem 520 may include multiple data caches. A cache controller 522 within memory subsystem 521 may include circuitry to manage the contents of one or more caches 523. For example, cache controller 522 may include circuitry to determine when and if an individual cache line or a group of cache lines should be evicted from one of the caches in accordance with a policy. In at least some embodiments, cache controller 522 may also include circuitry to limit the amount of modified (dirty) cached data that would be flushed to persistent memory upon a system power failure or other power loss event, in response to requests and commands, or other events.

In FIG. 5, memory subsystem 530 may comprise a system, device, or apparatus operable to retain and/or retrieve program instructions and/or data for a period of time (e.g., computer-readable media). Memory subsystem 530 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 500, is powered down. Local storage resource 550 may comprise computer-readable media (e.g., hard disk drive, floppy disk drive, CD-ROM, and/or other type of rotating storage media, flash memory, EEPROM, and/or another type of solid state storage media) and may be generally operable to store instructions and/or data. Each of the processes, methods and algorithms described herein may be embodied in, and fully or partially automated by, code modules executed by one or more computers or computer processors as depicted in FIG. 5. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage. For purposes of the claims, the phrase “computer storage medium,” “computer-readable storage medium,” and variations thereof, does not include waves, signals, and/or other transitory and/or intangible communication media, per se.

In computing environment 500, I/O subsystem 540 may comprise a system, device, or apparatus generally operable to receive and/or transmit data to/from/within computing environment 500. I/O subsystem 540 may represent, for example, a variety of communication interfaces, graphics interfaces, video interfaces, user input interfaces, and/or peripheral interfaces. As shown, I/O subsystem 540 may further communicate with various I/O devices such as a touch panel and display adapter.

As illustrated in FIG. 5, computing environment 500 may include one or more power control modules 570 and one or more power supply units (PSUs) 580. In at least some embodiments, power control modules 570 may include power distribution circuitry. In at least some embodiments, power control module(s) 570 may control the allocation of power generated by one or more of the power supply units (PSUs) 580 to other resources in computing environment 500. In some embodiments, one or more of the power control modules 570 may include a management controller (MC).

Each of the processes, methods and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from or rearranged compared to the disclosed example embodiments.

It will also be appreciated that various items are illustrated as being stored in memory or on storage while being used, and that these items or portions of thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Accordingly, the present invention may be practiced with other computer system configurations.

Conditional language used herein, such as, among others, “can,” “could,” “might,” “may,” “e.g.” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

The disclosure presented herein also encompasses the subject matter set forth in the following clauses:

Clause 1: A computer-implemented method for performing a database synchronization operation during a repartitioning or rebalancing of a partitioned database in a distributed computing system providing a multi-tenant database service, the method comprising:
receiving a request for a synchronization of data for a tenant of the multi-tenant database service, the data being stored in multiple partitions of the partitioned database;
in response to the request, generating a single sync token comprising a set of sort keys;
using the single sync token to identify a deterministic order for changes in the data for the tenant including when timestamps for a change are identical, wherein the changes are sorted by time, tenant, object, and property;
querying all partitions of the partitioned database and performing sort and deduplication to determine a set of changes to be provided in response to the request; and
returning the set of changes.

Clause 2: The computer-implemented method of clause 1, further comprising using a watermark to exclude recent ones of the changes.

Clause 3: The computer-implemented method of any of clauses 1 or 2, wherein the watermark is set as a current date and time.

Clause 4: The computer-implemented method of any of clauses 1 through 3, wherein the watermark is maintained by a middle-tier component.

Clause 5: The computer-implemented method of any of clauses 1 through 4, wherein changes more recent than the watermark are discarded.

Clause 6: The computer-implemented method of any of clauses 1 through 5, wherein tenant states in source and destination databases are used to determine from which database the changes are sourced.

Clause 7: The computer-implemented method of any of clauses 1 through 6, wherein all partitions in a sync boundary are combined as a single view having a global deterministic order of changes by timestamp, tenant ID, object ID and property ID.

Clause 8: The computer-implemented method of any of clauses 1 through 7, further comprising establishing a heartbeat on each partition that represents a last time that the partition was regularly updated.

Clause 9: The computer-implemented method of any of clauses 1 through 8, further comprising establishing a heartbeat on each partition that represents a last time that the partition was regularly updated, wherein the heartbeat is used to converge the watermark when a returned page from a partition is not full.

Clause 10: A computing device comprising:
one or more processors;
a memory in communication with the one or more processors, the memory having computer-readable instructions stored thereupon which, when executed by the one or more processors, cause the computing device perform operations comprising:
receiving a request for a synchronization of data for a tenant of a multi-tenant database service, the data being stored in multiple partitions of a partitioned database in a distributed computing system providing the multi-tenant database service;
in response to the request, generating a single sync token comprising a set of sort keys;
using the single sync token to identify a deterministic order for changes in the data for the tenant including when timestamps for a change are identical, wherein the changes are sorted by time, tenant, object, and property;
querying all partitions of the partitioned database and performing sort and deduplication to determine a set of changes to be provided in response to the request; and
returning the set of changes.

Clause 11: The computing system of clause 10, further comprising computer-readable instructions stored thereupon which, when executed by the one or more processors, cause the computing device perform operations comprising using a watermark to exclude recent ones of the changes.

Clause 12: The computing system of any of clauses 10 and 11, wherein the watermark is set as a current date and time.

Clause 13: The computing system of any clauses 10-12, wherein the watermark is maintained by a middle-tier component.

Clause 14: The computing system of any clauses 10-13, wherein changes more recent than the watermark are discarded.

Clause 15: The computing system of any clauses 10-14, wherein tenant states in source and destination databases are used to determine from which database the changes are sourced.

Clause 16: The computing system of any clauses 10-15, wherein all partitions in a sync boundary are combined as a single view having a global deterministic order of changes by timestamp, tenant ID, object ID and property ID.

Clause 17: The computing system of any clauses 10-16, further comprising computer-readable instructions stored thereupon which, when executed by the one or more processors, cause the computing device perform operations comprising:
establishing a heartbeat on each partition that represents a last time that the partition was regularly updated.

Clause 18: The computing system of any clauses 10-17, further comprising computer-readable instructions stored thereupon which, when executed by the one or more processors, cause the computing device perform operations comprising establishing a heartbeat on each partition that represents a last time that the partition was regularly updated, wherein the heartbeat is used to converge the watermark when a returned page from a partition is not full.

Clause 19: A computer-readable storage medium comprising computer-readable instructions stored thereupon which, when executed by one or more processors of a computing device, cause the computing device perform operations comprising:
receiving a request for a synchronization of data for a tenant of a multi-tenant database service, the data being stored in multiple partitions of a partitioned database in a distributed computing system providing the multi-tenant database service;
in response to the request, generating a single sync token comprising a set of sort keys;
using the single sync token to identify a deterministic order for changes in the data for the tenant including when timestamps for a change are identical, wherein the changes are sorted by time, tenant, object, and property;
querying all partitions of the partitioned database and performing sort and deduplication to determine a set of changes to be provided in response to the request; and
returning the set of changes.

Clause 20: The computer-readable storage medium of clause 19, wherein all partitions in a sync boundary are combined as a single view having a global deterministic order of changes by timestamp, tenant ID, object ID and property ID.

1. A computer-implemented method comprising:
receiving a request for a synchronization of data for a tenant of a multi-tenant database service provided by a distributed computing system, the data being stored in multiple partitions of a partitioned database and the request received during a database synchronization operation associated with a repartitioning or rebalancing of the partitioned database;
in response to the request, generating a single sync token comprising a set of sort keys;
identifying, based on the single sync token, a deterministic order for changes in the data for the tenant including when timestamps for a change are identical, wherein the changes are sorted by time, tenant, object, and property;
querying all partitions of the partitioned database and performing sort and deduplication to determine a set of changes to be provided in response to the request; and
returning the set of changes.

2. The computer-implemented method of claim 1, further comprising excluding, based on a watermark, recent ones of the changes.

3. The computer-implemented method of claim 2, wherein the watermark is set as a current date and time.

4. The computer-implemented method of claim 2, wherein the watermark is maintained by a middle-tier component.

5. The computer-implemented method of claim 2, wherein changes more recent than the watermark are discarded.

6. The computer-implemented method of claim 1, wherein tenant states in source and destination databases are used to determine from which database the changes are sourced.

7. The computer-implemented method of claim 1, wherein all partitions in a sync boundary are combined as a single view having a global deterministic order of changes by timestamp, tenant ID, object ID and property ID.

8. The computer-implemented method of claim 1, further comprising establishing a heartbeat on each partition that represents a last time that the partition was regularly updated.

9. The computer-implemented method of claim 2, further comprising establishing a heartbeat on each partition that represents a last time that the partition was regularly updated, wherein the heartbeat is used to converge the watermark when a returned page from the partition is not full.

10. A computing device comprising:
one or more processors;
a memory in communication with the one or more processors, the memory having computer-readable instructions stored thereupon which, when executed by the one or more processors, cause the computing device perform operations comprising:
receiving a request for a synchronization of data for a tenant of a multi-tenant database service, the data being stored in multiple partitions of a partitioned database in a distributed computing system providing the multi-tenant database service, the request received during a database synchronization operation associated with a repartitioning or rebalancing of the partitioned database;
in response to the request, generating a single sync token comprising a set of sort keys;
identifying, based on the single sync token, a deterministic order for changes in the data for the tenant including when timestamps for a change are identical, wherein the changes are sorted by time, tenant, object, and property;
querying all partitions of the partitioned database and performing sort and deduplication to determine a set of changes to be provided in response to the request; and
returning the set of changes.

11. The computing device of claim 10, further comprising computer-readable instructions stored thereupon which, when executed by the one or more processors, cause the computing device perform operations comprising excluding, based on a watermark, recent ones of the changes.

12. The computing device of claim 11, wherein the watermark is set as a current date and time.

13. The computing device of claim 11, wherein the watermark is maintained by a middle-tier component.

14. The computing device of claim 11, wherein changes more recent than the watermark are discarded.

15. The computing device of claim 10, wherein tenant states in source and destination databases are used to determine from which database the changes are sourced.

16. The computing device of claim 10, wherein all partitions in a sync boundary are combined as a single view having a global deterministic order of changes by timestamp, tenant ID, object ID and property ID.

17. The computing device of claim 10, further comprising computer-readable instructions stored thereupon which, when executed by the one or more processors, cause the computing device perform operations comprising:
establishing a heartbeat on each partition that represents a last time that the partition was regularly updated.

18. The computing device of claim 11, further comprising computer-readable instructions stored thereupon which, when executed by the one or more processors, cause the computing device perform operations comprising establishing a heartbeat on each partition that represents a last time that the partition was regularly updated, wherein the heartbeat is used to converge the watermark when a returned page from the partition is not full.

19. A computer-readable storage medium comprising computer-readable instructions stored thereupon which, when executed by one or more processors of a computing device, cause the computing device perform operations comprising:
receiving a request for a synchronization of data for a tenant of a multi-tenant database service, the data being stored in multiple partitions of a partitioned database in a distributed computing system providing the multi-tenant database service, the request received during a database synchronization operation associated with a repartitioning or rebalancing of the partitioned database;
in response to the request, generating a single sync token comprising a set of sort keys;
identifying, based on the single sync token, a deterministic order for changes in the data for the tenant including when timestamps for a change are identical, wherein the changes are sorted by time, tenant, object, and property;
querying all partitions of the partitioned database and performing sort and deduplication to determine a set of changes to be provided in response to the request; and
returning the set of changes.

20. The computer-readable storage medium of claim 19, wherein all partitions in a sync boundary are combined as a single view having a global deterministic order of changes by timestamp, tenant ID, object ID and property ID.
